(19) United States
(12) Patent Application Publication
(10) Pub. No.: US 2021/0113860 A1
(43) Pub. Date: Apr. 22, 2021

(54) POWERED AIR PURIFYING RESPIRATOR DEVICE

(71) Applicant: RPB Safety, LLC, Royal Oak, MI (US)

(72) Inventors: William C. Hamill, Troy, MI (US); Edward S. M. Williams, Christchurch (NZ); Julia Bartnik-Thumm, Christchurch (NZ); James A. Te Aika, Christchurch (NZ); Alan J. Gerrard, Christchurch (NZ); Samuel M. Kelly, Christchurch (NZ)

(21) Appl. No.: 17/073,094

(22) Filed: Oct. 16, 2020

Related U.S. Application Data
(60) Provisional application No. 62/916,729, filed on Oct. 17, 2019.

(51) Int. Cl. A62B 18/00; A62B 23/02; A42B 3/28

(52) U.S. Cl. CPC A62B 18/006; A42B 3/286; A62B 23/02

(57) ABSTRACT

A powered air purifying respirator (PAPR) device comprises an enclosure extending along a longitudinal axis between a first end of the enclosure and a second end of the enclosure. The enclosure defines an air inlet in fluid communication with environmental air. A filter module is disposed in the enclosure in fluid communication with the air inlet for filtering the environmental air to produce clean air. A blower system is disposed in the enclosure in fluid communication with the filter module for pressurizing the clean air. The enclosure includes an upper housing for receiving the filter module. A plate extends between the first end and the second end defining an air outlet in fluid communication with the filter module and the blower system. The air inlet is disposed adjacent the second end and the air outlet is disposed adjacent the first end.

### CROSS-REFERENCE TO RELATED APPLICATIONS

This application claims the benefit of U.S. Provisional application patent Ser. No. 62/916,729, filed on Oct. 17, 2019, the entire disclosure of which is hereby incorporated herein by reference in its entirety.

### BACKGROUND OF THE INVENTION

### 1. Field of the Invention

The present invention generally relates to respirator devices, and more particularly to a powered air purifying respirator (PAPR).

### 2. Description of the Prior Art

Powered air purifying respirator equipment is generally known in the art for providing breathable air to a user's breathing zone in a hazardous environment. The powered air purifying respirator (PAPR) is typically worn by the user as a backpack or attached to a belt which is worn around the user's waist. The PAPR is connected by a hose to, for example, a helmet or face shield worn by the user. The PAPR has a motor and a fan that pulls air through a filter and then supplies filtered air to the user inside the helmet or face shield. The motor is normally powered by a battery that is mounted to the PAPR.

One of the problems with known PAPR units is their bulk. They are typically fairly large and heavy. One reason for this is the volute of the blower system. It is generally a flat spiral shape and takes up significant room inside the PAPR when fit with the battery of the PAPR. The size of the battery also contributes to the bulk of the PAPR. To extend the period of time the unit can be used, conventional units use large batteries and this increases the weight of the unit. Also, to provide the needed air flow, conventional units use bigger fans which result in the need for bigger housings. Another problem with conventional PAPR units is the placement of the battery on the outside of the unit. This exposes the battery to environmental contaminants so that, in addition to the unit itself, the battery is required to be cleaned as well. The battery is also exposed to potential damage from impact with other items in the work area.

Conventional units are also difficult to assemble and clean. They typically have a number of parts that are screwed or bolted together. This also makes them difficult to clean since contaminants can get into narrow gaps and pocket-shaped geometry, as well as under screws. The contaminants then build-up, making it difficult to disassemble the unit. For example, if the battery is covered by a battery door, the external portions of the battery door, as well as the battery itself, are exposed to environmental contaminants due to the design of battery door. Typically, the hinge of the battery door provides several nooks and crannies for contaminates to accumulate in, and also allows for contaminates to enter the battery compartment. The battery being placed outside the PAPR unit also exposes it to potential damage from impact with other items in the work area.

### SUMMARY OF THE INVENTION

The present invention provides a powered air purifying respirator device for easy replacement of the filter module and cleaning of the unit. In addition, the present invention allows for replacement of the filter module without separate handling of a spark arrestor in the respirator device. Further, the present invention allows improved air flow across the filter module. The present invention further provides a door assembly provides for limiting contaminants from entering the interior of the respirator device.

The construction of the respirator device is light-weight, allowing for ease of use regardless of the stature of the user. The present invention provides a PAPR unit that is lighter in weight and more compact than other known units. Several features combine to make this possible. It is also easier to clean and maintain than known units.

The volute chamber is unique. The center line of the volute chamber is on an angle relative to the impeller. This enables the space inside the housing to be better utilized, without complicating the geometry of the housing. It also simplifies the balancing of the impeller, as the bottom face on the impeller can remain parallel to reference geometry of the housing. The design has been engineered to achieve a similar functional performance to a volute with a chamber that is not offset.

The layout of the PAPR is unique and allows the battery to fit at an angle while still maintaining a regular shaped housing. This geometry complements the layout of the filter relative to the inlet surface. Angling the filter so there is more open space around the inlet aids air to flow more evenly through a larger area of the filter. This is achieved by having the intake towards the bottom of the unit, and open space for area to distribute through the filter and the inlet towards the top of the unit. Overall, this layout provides an efficient use of space and helps utilize a larger area of the filter.

The battery of the present invention is completely enclosed in the housing. The battery can be removed for charging and replaced with another battery if needed. The unit can be quickly cleaned and decontaminated. There is no longer a need to clean the battery as it remains clean inside the unit. The battery also remains protected within the housing from physical damage during use and the battery connection remains clean.

The battery compartment door is designed to reduce features exposed to the outside. An internal hinge and retaining system is provided that reduces the ingress of contaminants such as water and dust in these parts. This makes cleaning easier, as there are no small nooks and crannies that contaminants could accumulate in. The retainer door allows the battery door to remain connected to the unit at all times, so it doesn't get lost. It's also designed to be removed or replaced as needed. The door, latch, battery or mounting features are not susceptible to being damaged or caught on anything in the work area.

The spark arrestor location of the present invention is unique. Traditional methods of mounting the spark arrestor sandwich it together with the filter module. The present invention separates the two, the spark arrestor is mounted with a space between it and the filter module. The benefits of this include but are not limited to: the spacing allows the filter module to be further protected from traditional mounting methods. i.e. should the spark arrestor get hot or have hot molten metal sit/stick to it, it will not damage the pre-filter, it helps aid with airflow and there is less handling of the spark arrestor compared to traditional methods.

It is one aspect of the present invention to provide a powered air purifying respirator (PAPR) device. The PAPR device comprises an enclosure extending along a longitudinal axis between a first end of the enclosure and a second end of the enclosure. The enclosure defines an air inlet in fluid communication with environmental air. A filter module is disposed in the enclosure in fluid communication with the air inlet for filtering the environmental air to produce clean air. A blower system is disposed in the enclosure in fluid communication with the filter module for pressurizing the clean air. The enclosure includes an upper housing for receiving the filter module. A plate extends between the first end and the second end defining an air outlet in fluid communication with the filter module and the blower system. The air inlet is disposed adjacent the second end and the air outlet is disposed adjacent the first end.

It is another aspect of the present invention to provide a powered air purifying respirator (PAPR) device. The PAPR device comprises an enclosure extending along a longitudinal axis between a first end of the enclosure and a second end of the enclosure. The enclosure defines an air inlet in fluid communication with environmental air. A filter module is disposed in the enclosure in fluid communication with the air inlet for filtering the environmental air to produce clean air. A blower system is disposed in the enclosure in fluid communication with the filter module for pressurizing the clean air. The enclosure includes an upper housing for receiving the filter module. A spark arrestor is attached to the upper housing and spaced from the filter module for removing flammable debris from the environmental air.

It is another aspect of the present invention to provide a powered air purifying respirator (PAPR) device. The PAPR device comprises an enclosure extending along a longitudinal axis between a first end of the enclosure and a second end of the enclosure. The enclosure defines an air inlet in fluid communication with environmental air. A filter module is disposed in the enclosure in fluid communication with the air inlet for filtering the environmental air to produce clean air. A blower system is disposed in the enclosure in fluid communication with the filter module for pressurizing the clean air. The enclosure includes an upper housing for receiving the filter module. The upper housing defines a plurality of slots forming the air inlet adjacent a bottom surface of the enclosure. A plurality of ridges are adjacent the plurality of slots and extend parallel to the longitudinal axis to prevent water and contaminates from entering the air inlet.

It is another aspect of the present invention to provide a blower system for a powered air purifying respirator (PAPR) device. The blower system comprises a volute having a tubular shape. A central portion is in fluid communication with the volute. An impeller is disposed in the central portion for rotation about a center axis to draw air into the blower system. The volute extends between a first volute end, adjacent the central portion, and a second volute end for fluid connection with a hose of the PAPR. The volute extends radially outwardly from the central portion and extends helically about the center axis between the first volute end and the second volute end. The blower system is disposed between a back surface of an enclosure and a plate of the enclosure. The impeller includes a flat portion extending parallel to the back surface.

It is another aspect of the present invention to provide a powered air purifying respirator (PAPR) device. The PAPR device comprises an enclosure extending along a longitudinal axis between a first end and a second end to define an interior of the enclosure. A blower system is disposed in the enclosure for pressurizing air. An electrical power source is disposed in the enclosure for powering the blower system. A door assembly is attached to the enclosure to provide access to the electrical power source. The door assembly includes at least one internal hinge disposed in the enclosure and a panel moveably connected to the at least one internal hinge. The panel is moveable between a closed position and an open position. In the closed position, the panel covers the second end to secure the electrical power source in the interior. In the open position, the panel is spaced from the second end with the electrical power source being releasable from the interior. At least one internal hinge is disposed in the interior to prevent environmental contaminates from accumulating on the at least one internal hinge.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 perspective view of a respirator device according to one embodiment of the present invention;

FIG. 2 is a cross-sectional view of the respirator device along the length of the respirator device;

FIG. 3 is a cross-sectional view of the respirator device along the width of the respirator device;

FIG. 4 is a perspective view of the respirator device with a cover of the respirator device removed;

FIG. 5 is a disassembled perspective view of an upper housing of the respirator device;

FIG. 6 is a cross-sectional view of the blower system;

FIG. 7 is a perspective view of a door assembly to the lower housing; and

FIG. 8 is a perspective view of a lower housing of the respirator device with the upper housing removed.

FIG. 9 is the powered air purifying respirator device connected to a headgear.

### DESCRIPTION OF THE ENABLING EMBODIMENT

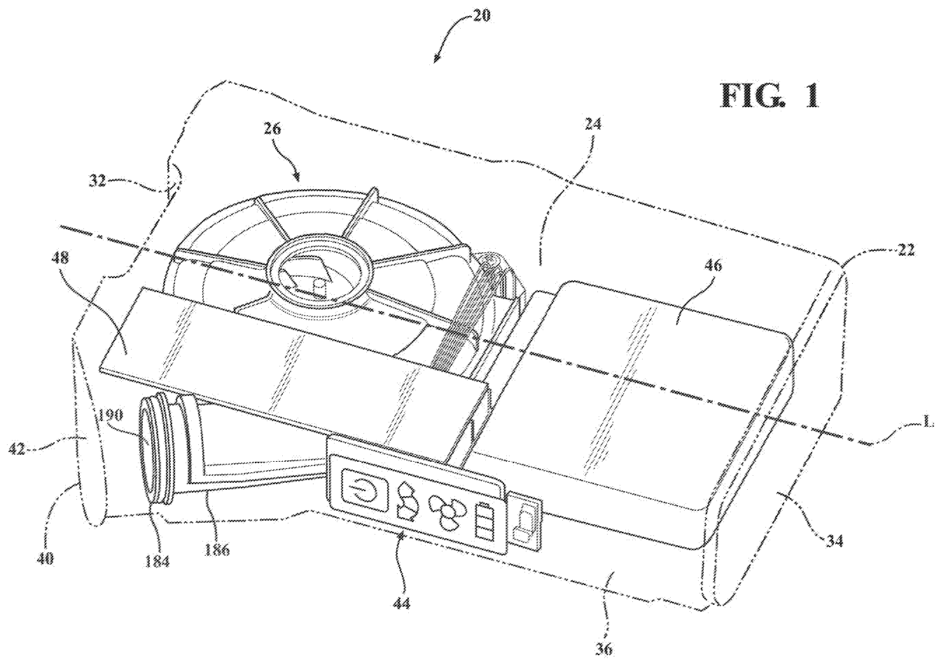

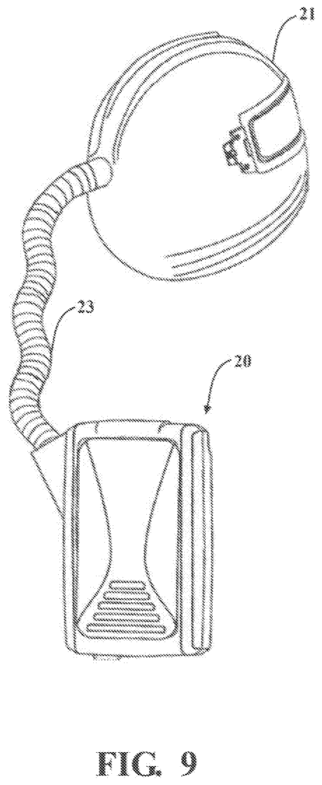

Referring to the figures, wherein like numerals indicate corresponding parts throughout the several views, a respirator device 20 constructed in accordance with one embodiment of the present invention is generally shown in FIG. 1. Typically, a respirator device 20 is secured to a user and supplies clean air to the user. FIG. 9 illustrates an example of the respirator 20 of the present invention operatively connected to headgear, such as a helmet 21, through a hose 23.

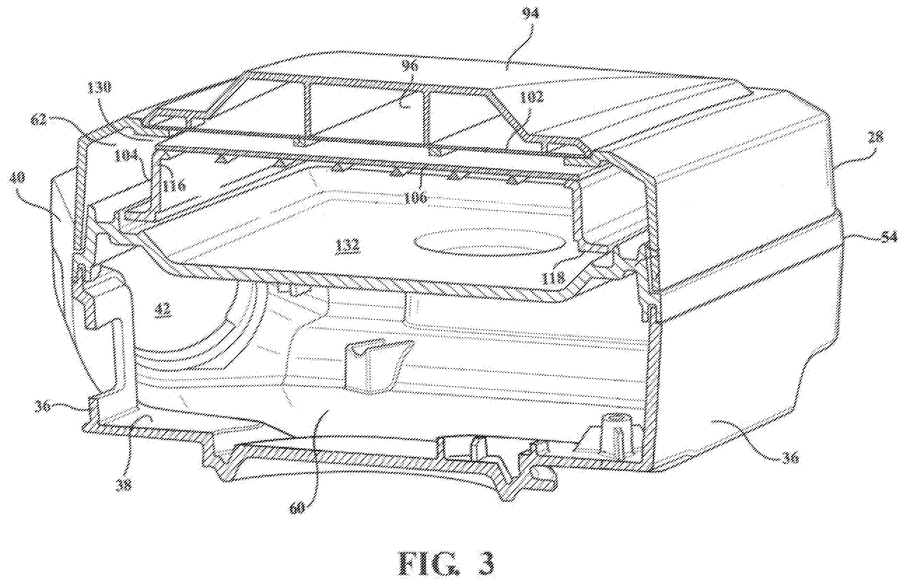

As best illustrated in FIGS. 1-3, the respirator device 20 includes an enclosure 22 extending between a first end and a second end spaced from one another along a longitudinal axis L. The enclosure has a generally rectangular shape and defines an interior 24 for containing a blower system 26 to draw air into the device 20, pressurize the air, and provide filtered air to the user. The enclosure 22 is arranged to be a generally water-proof and dust-proof interior 24 in operation. The enclosure 22 includes an upper housing 28 and a lower housing 30, each having a generally rectangular shape, with the upper housing 28 and the lower housing 30 opposite one another defining the interior 24. The lower housing 30 has a plurality of surfaces, including a top surface 32, a bottom surface 34, a pair of side surfaces 36, and a back surface 38 connecting the top surface 32, the bottom surface 34, and the pair of side surfaces 36. A connecting portion 40, having a tubular shape, extends outwardly at an oblique angle from one of the pair of side surfaces 36 to define a receptacle 42 for receiving a hose, thereby providing a fluid connection between the respirator device 20 and the user. The lower housing 30 has a user interface 44 disposed on one of the pair of side surfaces 36 for controlling the respirator device 20 and for providing feedback to the user. The user interface 44 includes an assembly of indicators for providing status information to the user. It should be appreciated that, in one embodiment, the status information may include air flow rate, impeller speed, remaining electrical power, and any information measures by the plurality of sensors. The user interface 44 may include user inputs for configuring the respirator device 20.

An electrical power source 46, which in the one embodiment is a battery, is disposed in the enclosure 22 for powering the respirator device 20. The enclosure 22 has a control unit 48 coupled to the user interface 44, the blower system 26, and the electrical power source 46 for operating the respirator device 20. A filter module 50, having a generally rectangular shape, is disposed in the interior 24 and extends at an oblique angle relative to the longitudinal axis L between the first end and the second end in the assembled position for filtering contaminants from environmental air. It will be appreciated by those of ordinary skill in the art that the general rectangular shape of the present invention could be any number of other shapes, for example, oval, square, circular, etc.

A plate 54, having a generally rectangular shape, extends between the first end and the second end and is sandwiched between the lower housing 30 and the upper housing 28 for sealing the lower housing 30 from the environmental air. The plate 54 divides the interior 24 into a lower compartment 60 and an upper compartment 62. The lower compartment 60 extends between the plate 54 and the lower housing 30, and the upper compartment 62 extends between the plate 54 and the upper housing 28. In one embodiment, the lower housing 30, the upper housing 28, and the plate 54 form a snap-fit connection requiring no additional hardware, such as screws or rivets, to be securely attached to one another. The plate 54 includes a first flange 72, having a circular shape, extending into the lower compartment 60 to connect to the blower system 26. The blower system 26 is disposed between the back surface 38 of the enclosure 22 and the plate 54 of the enclosure 22.

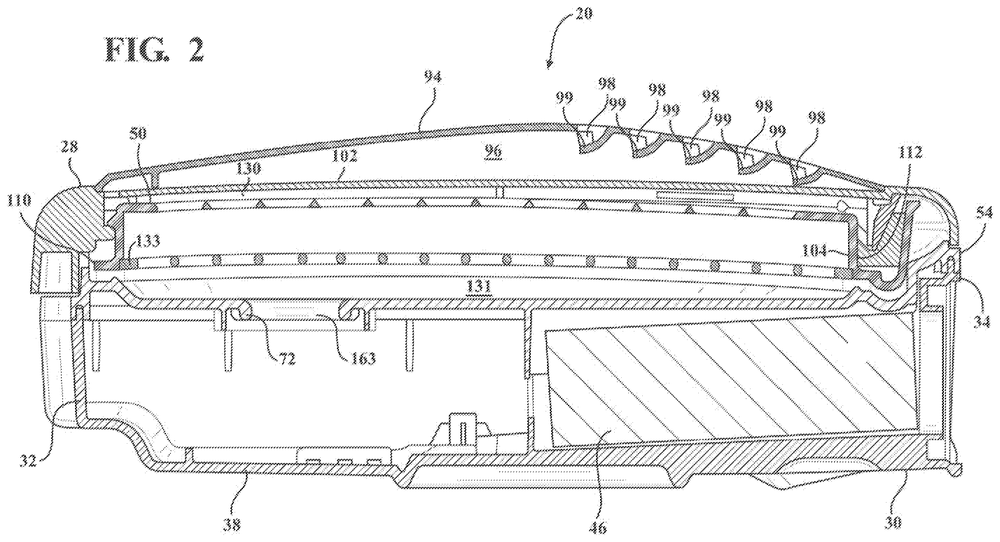

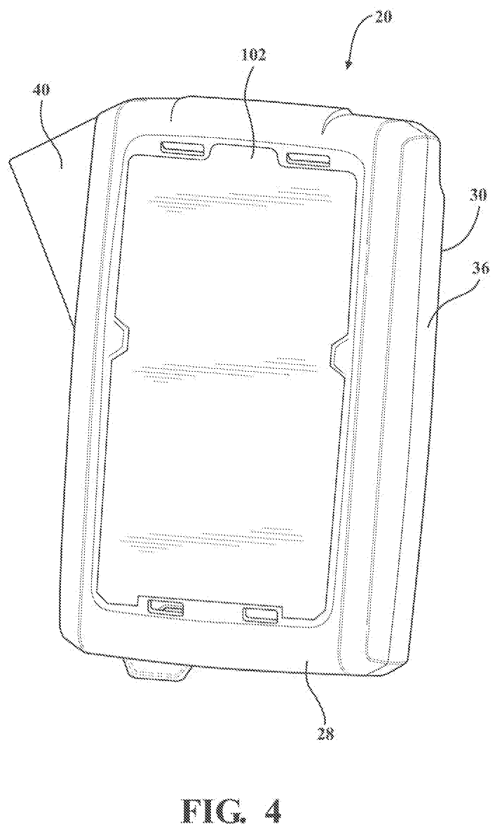

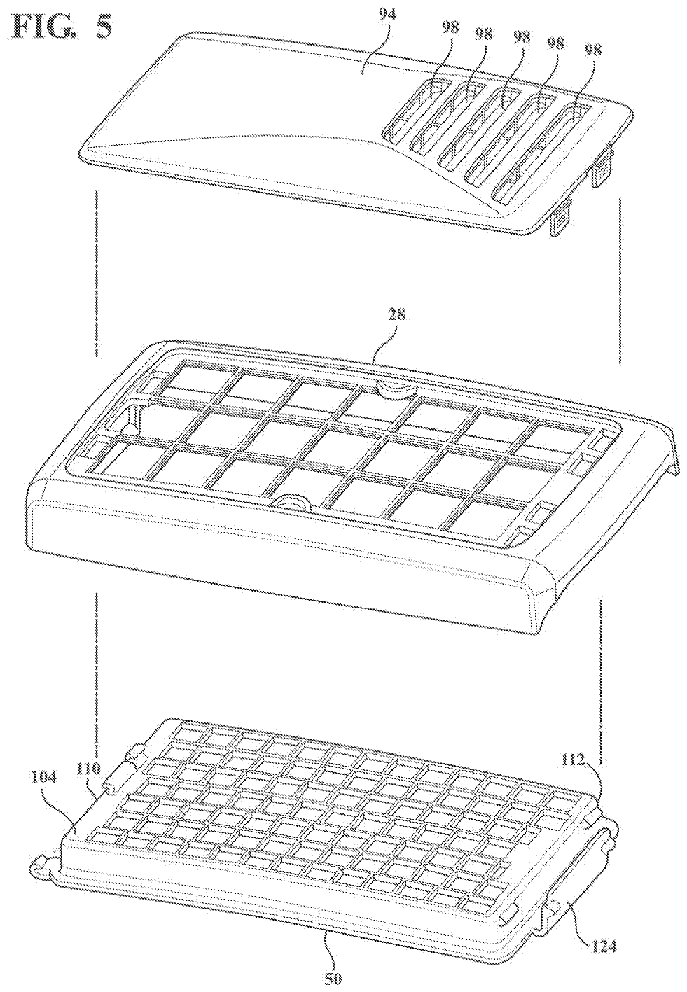

Referring to FIGS. 2-5, a cover 94, having a generally rectangular shape, attaches to the upper housing 28 of the enclosure 22. The cover 94 defines an air inlet downstream of and in fluid communication with the filter module 50 and in-fluid communication with the blower system 26. The cover 94 defines an entry chamber 96 and a plurality of slots 98, with the entry chamber 96 extending between the upper housing 28 and the cover 94 and the plurality of slots 98 forming the air inlet adjacent the bottom surface 34 of the enclosure 22 and extending through the cover 94 to provide fluid communication between the environmental air and the entry chamber 96. The cover 94 includes a plurality of ridges 99 disposed adjacent the plurality of slots extending generally parallel to the longitudinal axis L to prevent water and contaminants from entering the air inlet. A spark arrestor 102, having a generally rectangular shape, is attached to the enclosure 22 and spaced from the filter module 50 for removing flammable debris from the environmental air. The filter module 50 and the spark arrestor 102 may be spaced from one another to prevent damage to the filter module 50.

The filter module 50 includes a frame 104, having a generally rectangular shape, connecting to the enclosure 22, and a filter membrane 108 attached to the frame 104 of the filter module 50 and spaced above the plate 54. The frame 104 connects to the upper housing 28 and is disposed in the upper compartment 62 adjacent the plate 54. The frame 104 extends between a first edge 110 and a second edge 112 with the frame 104 releasably engaging the enclosure 22. The first edge 110 engages the first end and the second edge 112 engages the second end to secure the filter module 50 to the enclosure 22 to define an assembled position. A clip 124 extends outwardly from the filter module 50 the second edge 112 for engaging the upper housing 28.

The filter module 50 is spaced from the spark arrestor 102 and the cover 94 of the upper housing 28 to define a first gap 130 extending between the filter module 50 and the upper housing 28. In other words, the spark arrestor 102 and the filter module 50 are spaced from one another in the assembled position to prevent the flammable debris from contacting the filter module 50. The first gap 130 helps prevent the filter module 50 from over-heating, melting, or igniting. In addition, the first gap 130 allows for improved fluid communication between the spark arrestor 102 and the filter module 50, and the first gap 130 provides for easier cleaning of the respirator device 20. More specifically, the first gap 130 allows a user to remove the filter module 50 from the enclosure 22 without the user engaging the spark arrestor 102.

The filter module 50 is spaced from the plate 54 to define a second gap 131 and form an intake chamber 132 extending between the plate 54 and the frame 104 for containing filtered air, whereby the intake chamber 132 is in fluid communication with the blower system 26. In particular, the intake chamber 132 may span the entire area of the filter module 50 to allow the fluid to flow across a large area of the filter module 50. It should be appreciated that the filter module 50 may extend at an oblique angle relative to the upper housing 28 and the plate 54 of the lower housing 30, such that the first gap 130 is greater toward the second end (e.g., the bottom surface 34), and the second gap 131 is greater toward the first end (e.g., the top surface 32) for less impeded fluid communication between the first gap 130 and the intake chamber 132.

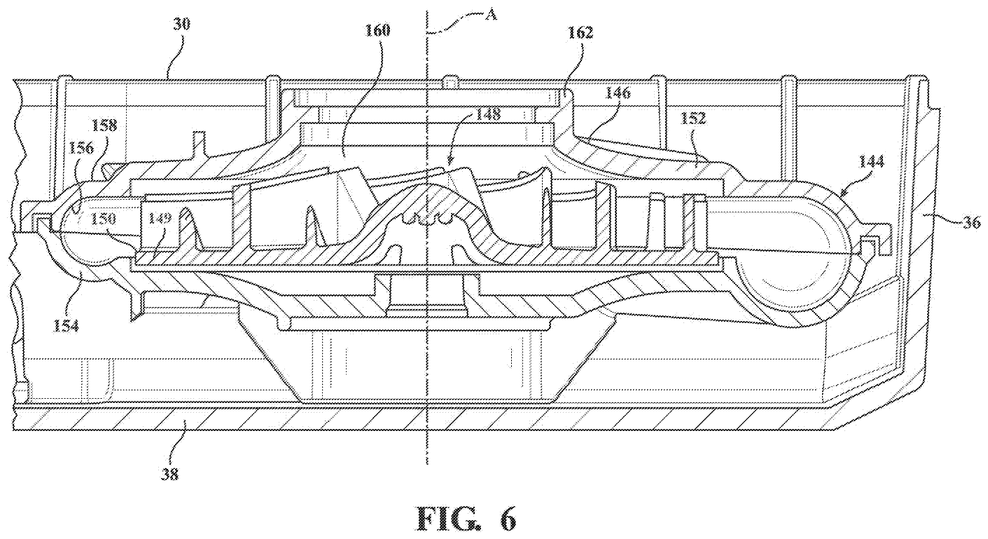

Referring to FIG. 6, the blower system 26 includes a volute 144, having a tubular shape, a central portion 146 connected to and in fluid communication with the volute 144, an impeller 148 disposed in the central portion 146, and a motor for rotating the impeller 148 about a center axis A. The impeller 148 includes a flat portion 149 being generally parallel to the back surface 38 and extending radially outwardly about the center axis A to form a periphery 150. The volute 144 and the central portion 146 are each formed by an upper shell 152 and a lower shell 154, with the upper shell 152 and the lower shell 154 connected to one another forming an inner surface 156 and an outer surface 158.

The central portion 146 defines a central chamber 160 extending between the upper shell 152 and the lower shell 154, with the central chamber 160 extending radially outwardly from the center axis A. A second flange 162 extends from the upper shell 152 along the center axis A to engage the first flange 72 and provide fluid communication between the intake chamber 132 and the central chamber 160. In other words, at the flange 162, the plate 54 of the enclosure 22 defines an air outlet 163 upstream of the filter module 50 in fluid communication with the filter module 50 and the blower system 26. In this way, the air inlet is disposed adjacent the second end and the air outlet is disposed adjacent the first end to improve air flow across the filter module 50.

The volute 144 extends radially outwardly from the central portion 146 in a helical shape between a first volute end adjacent the central portion 146 and a second volute end 184 adjacent the connecting portion 40, with the volute 144 in fluid communication with the central chamber 160. The first volute end is disposed adjacent the plate 54 and the second volute end 184 is disposed adjacent the back surface 38. In other words, the volute 144 extends helically about the center axis A toward the back surface 38 from the first volute end to the second volute end 184, with the distance between the volute 144 and the back surface 38 decreasing from the first volute end to the second volute end 184. The term “helically” refers to the shape of a helix (i.e., an upward/downward spiral). The helical shape may have a varying or constant radius along the center axis A. It should be appreciated that, in one embodiment, the central portion 146 is generally parallel to the back surface 38 to stabilize the impeller 148 and to utilize more of the lower compartment 60. The diameter of the volute 144 increases from the first volute end to the second volute end 184 along the volute 144. The volute 144 forms a neck 186 and a discharge tube 188, with the discharge tube 188 extending along a straight path tangential to the center axis A between the neck 186 and the second volute end 184, with the second volute end 184 for fluid connection with the hose 23 of the PAPR. The discharge tube 188 is disposed in the connecting portion 40 and defines a discharge port 190 for fluid connection with the hose.

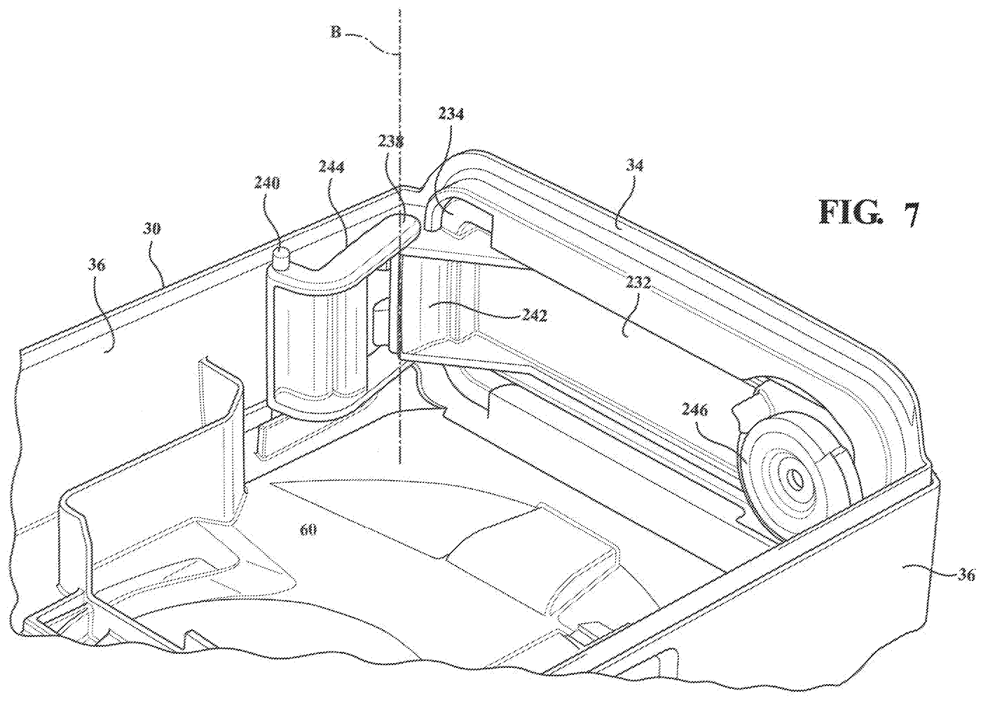

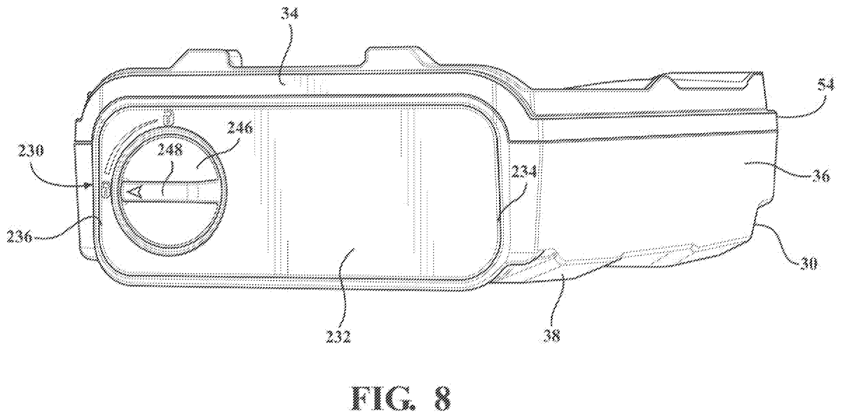

Referring to FIGS. 7 and 8, the lower housing 30 defines an opening 228, having a generally rectangular shape, extending through the bottom surface 34 adjacent the lower compartment 60 for receiving the electrical power source 46. In one embodiment, the electrical power source 46 may be a battery. A door assembly 230 is pivotally attached to the enclosure 22 between an open position and a closed position to provide access to said electrical power source 46. The open position is defined by the electrical power source 46 being releasable from the enclosure 22, with the panel 232 spaced from the second end, and the closed position is defined by the door assembly 230 sealing the electrical power source 46 from the environmental air in the enclosure 22. The door assembly 230 includes a panel 232, having a generally rectangular shape, and at least one internal hinge disposed in the interior 24 to prevent environmental contaminates from accumulating on the at least one internal hinge. The panel 232 extends between a proximal end 234, with the proximal end connecting to the at least one hinge, and a distal end 236, for covering the electrical power source 46. The at least one internal hinge is pivotable about a center of rotation B. The at least one internal hinge defines a first pivotable connection 238 between the at least one internal hinge and the proximal end 234 and defines a second pivotable connection 240 between the at least one internal hinge and the enclosure 22. The first pivotable connection 238 and the second pivotable connection 240 allow the distal end 236 to rotate away from the interior 24 and allow the proximal end 234 to rotate away from the interior 24 for protecting the interior 24 from the environmental air. In other words, the center of rotation B is moveable relative to the second pivotable connection 240.

The first pivotable connection 238 is formed between the at least one hinge and the panel 232, and the second pivotable connection 240 is formed between the at least one hinge and the enclosure 22. The door assembly 230 provides for keeping an electrical connection between the electrical power source 46 and the control unit 48 free from contaminates. In one embodiment, the at least one internal hinge includes a first internal hinge 242 and a second internal hinge 244, with the first internal hinge 242 attached to the panel 232 and pivotally connected to the second internal hinge 244, and with the second internal hinge 244 pivotally connected to the lower housing 30 and the first internal hinge 242. A lock 246 is disposed at and extends from the distal end 236 of the panel 232 for securing the panel 232 to the lower housing 30 in the closed position. The lock 246 includes a knob 248 for rotating the lock 246 between a locked position, wherein the panel 232 is immovably secured to the lower housing 30, and an unlocked position, wherein the lock 246 is disengaged from the lower housing 30 and the panel 232 is pivotable between the closed position and the open position. In the open position, the proximal end 234 is not disposed in the interior 24.

The design of the respirator device 20 described above provides for a generally light-weight and compact design, while maintaining improved airflow through the blower system 26. Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A powered air purifying respirator (PAPR) device comprising:
an enclosure extending along a longitudinal axis between a first end of said enclosure and a second end of said enclosure;
said enclosure defining an air inlet in fluid communication with environmental air;
a filter module disposed in said enclosure in fluid communication with said air inlet for filtering said environmental air to produce clean air;
a blower system disposed in said enclosure in fluid communication with said filter module for pressurizing said clean air;
said enclosure including an upper housing for receiving said filter module;
a plate extending between said first end and said second end defining an air outlet in fluid communication with said filter module and said blower system; and
wherein said air inlet is disposed adjacent said second end and said air outlet is disposed adjacent said first end.

2. The PAPR device as set forth in claim 1, wherein said filter module extends from said first end toward said second end at an oblique angle relative to said plate.

3. The PAPR device as set forth in claim 1, wherein said filter module extends from said first end toward said second end at an oblique angle relative to said upper housing.

4. The PAPR device as set forth in claim 1, wherein said filter module and said upper housing define a first gap between said filter module and said upper housing with said first gap being greater toward said second end than toward said first end; and
wherein said filter module and said plate define a second gap between said filter module and said plate with said second gap being greater toward said first end than toward said second end.

5. The PAPR device as set forth in claim 1, wherein said upper housing defines a plurality of slots forming said air inlet adjacent a bottom surface of said enclosure; and
wherein a plurality of ridges extending parallel to said longitudinal axis are disposed adjacent said plurality of slots to prevent water and contaminates from entering said air inlet.

6. The PAPR device as set forth in claim 1, further including a spark arrestor attached to said upper housing and being spaced from said filter module for removing flammable debris from said environmental air.

7. The PAPR device as set forth in claim 1 further including a blower system for a powered air purifying respirator (PAPR) device, said blower system comprising:
a volute having a tubular shape;
a central portion in fluid communication with said volute;
an impeller disposed in said central portion for rotation about a center axis to draw air into said blower system;
said volute extending between a first volute end adjacent said central portion and a second volute end for fluid connection with a hose of said PAPR device; and
wherein said volute extends radially outwardly from said central portion and extends helically about said center axis between said first volute end and said second volute end.

8. The PAPR device as set forth in claim 7, wherein said blower system is disposed between a back surface of an enclosure and a plate of said enclosure; and
wherein said impeller includes a flat portion extending parallel to said back surface.

9. A powered air purifying respirator (PAPR) device comprising:
an enclosure extending along a longitudinal axis between a first end of said enclosure and a second end of said enclosure;
said enclosure defining an air inlet in fluid communication with environmental air;
a filter module disposed in said enclosure in fluid communication with said air inlet for filtering said environmental air to produce clean air;
a blower system disposed in said enclosure in fluid communication with said filter module for pressurizing said clean air;
said enclosure including an upper housing for receiving said filter module; and
a spark arrestor attached to said upper housing and spaced from said filter module for removing flammable debris from said environmental air.

10. The PAPR device as set forth in claim 9, wherein said upper housing defines a plurality of slots forming said air inlet adjacent a bottom surface of said enclosure; and
wherein a plurality of ridges extending parallel to said longitudinal axis are disposed adjacent said plurality of slots to prevent water and contaminates from entering said air inlet.

11. The PAPR device as set forth in claim 9, wherein said filter module and said upper housing define a first gap between said filter module and said upper housing with said first gap being greater toward said second end than toward said first end; and
wherein said filter module and said plate define a second gap between said filter module and said plate with said second gap being greater toward said first end than toward said second end.

12. A powered air purifying respirator (PAPR) device comprising:
an enclosure extending along a longitudinal axis between a first end of said enclosure and a second end of said enclosure;
said enclosure defining an air inlet in fluid communication with environmental air;
a filter module disposed in said enclosure in fluid communication with said air inlet for filtering said environmental air to produce clean air;
a blower system disposed in said enclosure in fluid communication with said filter module for pressurizing said clean air;
said enclosure including an upper housing for receiving said filter module;
wherein said upper housing defines a plurality of slots forming said air inlet adjacent a bottom surface of said enclosure; and
a plurality of ridges adjacent said plurality of slots and extending parallel to said longitudinal axis to prevent water and contaminates from entering said air inlet.

13. A blower system for a powered air purifying respirator (PAPR) device, said blower system comprising:
a volute having a tubular shape;
a central portion in fluid communication with said volute;
an impeller disposed in said central portion for rotation about a center axis to draw air into said blower system;
said volute extending between a first volute end adjacent said central portion and a second volute end for fluid connection with a hose of said PAPR device; and
wherein said volute extends radially outwardly from said central portion and extends helically about said center axis between said first volute end and said second volute end; and
wherein said blower system is disposed between a back surface of an enclosure and a plate of said enclosure; and
wherein said impeller includes a flat portion extending parallel to said back surface.

14. The blower system as set forth in claim 13, wherein said first volute end is disposed adjacent said plate and said second volute end is disposed adjacent said back surface.

15. The blower system as set forth in claim 13, wherein a diameter of said volute increases between said first volute end and said second volute end.

16. A powered air purifying respirator (PAPR) device comprising:
an enclosure extending along a longitudinal axis between a first end and a second end to define an interior of said enclosure;
a blower system disposed in said enclosure for pressurizing air;
an electrical power source disposed in said enclosure for powering said blower system;
a door assembly attached to said enclosure to provide access to said electrical power source;
said door assembly including at least one internal hinge disposed in said enclosure and a panel moveably connected to said at least one internal hinge;
said panel being moveable between a closed position and an open position whereby, in said closed position, said panel covers said second end to secure said electrical power source in said interior and, in said open position, said panel is spaced from said second end with said electrical power source being releasable from said interior; and
wherein said at least one internal hinge is disposed in said interior to prevent environmental contaminates from accumulating on said at least one internal hinge.

17. The PAPR device as set forth in claim 16, wherein said at least one hinge defines a first pivotable connection and a second pivotable connection, with said first pivotable connection being formed between said at least one hinge and said panel and said second pivotable connection being formed between said at least one hinge and said enclosure.

18. The PAPR device as set forth in claim 16, wherein said panel extends between a proximal end and a distal end with said proximal end connected to said at least one hinge; and
whereby in said open position said proximal end is not disposed in said interior.

19. The PAPR device as set forth in claim 18, further including a lock disposed at said distal end for securing said panel to said enclosure in said closed position.
